(19) United States
(12) Patent Application Publication
(10) Pub. No.: US 2001/0052338 A1
(43) Pub. Date: Dec. 20, 2001

(54) Method and apparatus for determining the extent of wear of a fuel pump forming part of a fuelling system

(76) Inventor: Martin Kenneth Yates, East Haddon (GB)

Correspondence Address: MICHAEL BEST & FRIEDRICH, LLP, 100 E WISCONSIN AVENUE, MILWAUKEE, WI, 53202, US

(21) Appl. No.: 09/821,718

(22) Filed: Mar. 29, 2001

(30) Foreign Application Priority Data
Mar. 30, 2000 (GB) 0007583.8

(51) Int. Cl. F02M 37/04

(52) U.S. Cl. 123/506; 73/119 A

(57) ABSTRACT

A method for monitoring the extent of wear a fuel pump forming part of a fuelling system for an engine, comprising the steps of delivering fuel from the fuel pump to a metering valve arrangement for regulating fuel flow from the pump to the engine, regulating the pressure drop across the meter, valve arrangement by means of a spill valve arrangement comprising a spill valve member, monitoring the position of the spill valve member so as to enable the fuel flow delivered by the pump to be determined, and using the measured pump delivery flow to provide an indication of fuel leakage from the pump. The invention also relates to an apparatus for performing the method of the present invention.

The invention relates to a method for determining the extent of wear of a fuel pump forming part of a fuelling system. In particular, the invention relates to a method for determining the extent of wear of a fuel pump forming part of a fuelling system for an aircraft engine. The invention also relates to an apparatus for determining the extent of wear of a fuel pump.

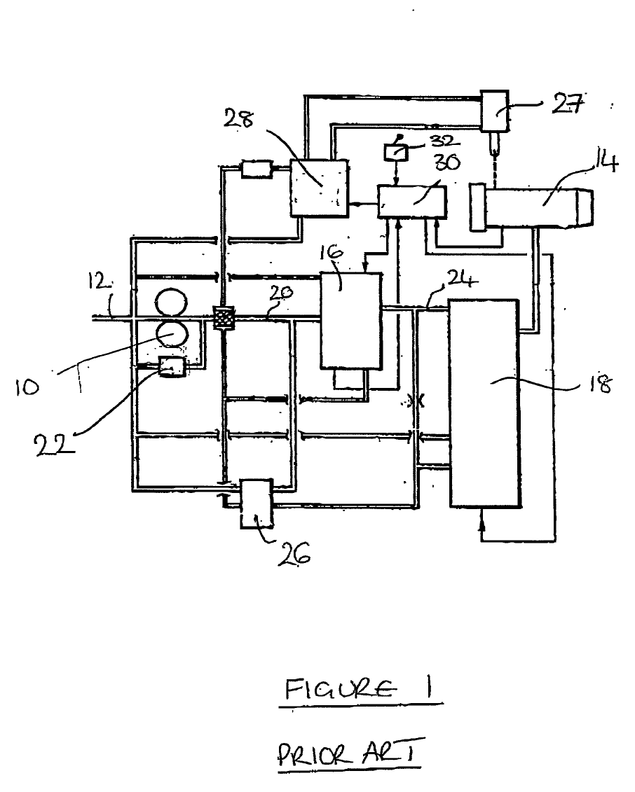

FIG. 1 is a schematic diagram of a conventional fuelling system for an aircraft engine including a pump 10 which receives fuel at relatively low pressure through an inlet passage 12, the pump 10 being driven by means of a drive shaft associated with the engine 14. The pump 10 delivers fuel through a pump outlet to a delivery passage 20, from where fuel is delivered to a metering valve arrangement 16 and a pressure regulating shut-off valve arrangement 18 which serve to regulate fuel flow to the engine. Fuel is delivered from the metering valve arrangement 16 to the pressure regulating shut-off valve arrangement 18 through an outlet passage 24. A spring loaded pressure relief valve 22 is connected between the delivery passage 20 and the inlet passage 12 to the pump 10. In normal operation, a spill valve 26 is responsive to fuel pressure in the delivery passage 20 and in the outlet passage 24 and serves to spill fuel from the delivery passage 20 to the inlet passage 12 so as to maintain a substantially constant pressure drop across the metering valve arrangement 16.

The system also includes an actuator 27 to which operating pressure is supplied by way of a control device 28, the actuator 27 serving to vary the geometry of the guide vanes of a compressor of the associated engine. The metering valve arrangement 16, the pressure regulating shut-off valve arrangement 18 and the control device 28 are responsive to signals from a digital control circuit 30, which in turn is responsive to signals from the engine 14 and the metering valve arrangement 16. The control circuit 30 is also responsive to signals from an engine speed demand device 32.

In order to permit replacement or servicing of the fuel pump at an appropriate time, it is desirable to be able to monitor the extent of wear of the fuel pump. It is an object of the present invention to provide a method and apparatus for doing so.

According to a first aspect of the present invention mere is provided a method for monitoring the extent of wear a fuel pump having a known displacement, the pump forming part of a fuelling system for an engine, the method comprising the steps of;

delivering fuel from the fuel pump to a metering valve arrangement for regulating fuel flow from the pump to the engine,

regulating the pressure drop across the metering valve arrangement by means of a spill valve arrangement comprising a spill valve member,

monitoring the position of the spill valve member so as to enable the fuel flow delivered by the pump to be calculated, and

using the measured pump delivery flow to provide an indication of fuel leakage from the pump.

The internal fuel leakage from the pump provides an indication of the extent of wear of the pump.

The method may include the steps of;

measuring the speed of the pump at a predetermined time, and

using the known pump displacement, the measured pump speed and the measured pump delivery flow at the predetermined time to provide an indication of the fuel leakage from the pump.

Conveniently, the method may include the step of calculating a pump leakage coefficient to provide an indication of the extent of wear of the pump.

Preferably, the predetermined time occurs during a starting sequence of the engine, the pump displacement, the pump speed and the pump delivery flow being measured during the starting sequence of the engine.

The method may include the further steps of;

generating an output signal indicative of the fuel leakage from the pump and

comparing the output signal with a predetermined maximum leakage value for the pump. The predetermined maximum fuel leakage value for the pump is preferably equal to the maximum allowable fuel leakage from the pump which still permits an adequate fuel flow to be delivered by the pump during the critical phases of engine operation, for example during take-off.

The method may also include the step of generating an output warning signal if the output signal exceeds the predetermined maximum fuel leakage value.

Alternatively, the method may include the step of providing an output signal when the fuel leakage from the pump exceeds an amount less than the predetermined maximum fuel leakage value so as to provide an indication of the period of time for which the pump can still be used before servicing or replacement is required.

According to a second aspect of the present invention there is provided an apparatus for performing the method herein described, comprising;

a metering valve arrangement for regulating fuel flow from the pump to the engine,

a spill valve arrangement comprising a spill valve member for regulating the pressure drop across the metering valve arrangement, and

means for monitoring the position of the spill valve member so as to enable the pump delivery flow, and hence the fuel leakage from the pump, to be determined.

The spill valve arrangement preferably includes an inlet port, a fist outlet port and an additional outlet port such that, in use, when the spill valve member is moved to an open position to permit fuel to spill through the first outlet port to a pump inlet, fuel is able to escape through the additional outlet port.

The apparatus preferably includes a pressure sensor for sensing the pressure of fuel flowing through the additional outlet port and for providing an output signal indicative of the position of the spill valve member.

The apparatus may further comprise means, such as a computer, for receiving the output signal and for calculating the fuel leakage from the pump, said means being arranged to provide an output warning signal if the calculated fuel leakage from the pump exceeds a predetermined amount.

Conveniently, the additional outlet port communicates with a filter passage provided with a restriction, the restriction permitting fuel pressure within the further passage to decrease when the spill valve member is moved to a position in which the additional outlet port is closed.

The provision of the restriction also ensures air within the further passage can escape when the spill valve member is moved to the open position.

The invention will now be described, by way of example only, with reference to the accompanying figures in which:

FIG. 1 is a schematic diagram of a conventional fuelling system for an aircraft engine,

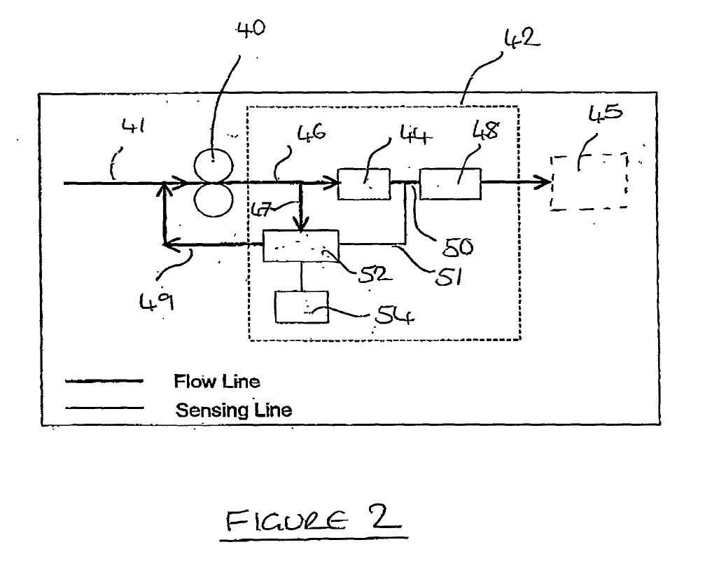

FIG. 2 is a schematic diagram of an apparatus in accordance with an embodiment of the invention,

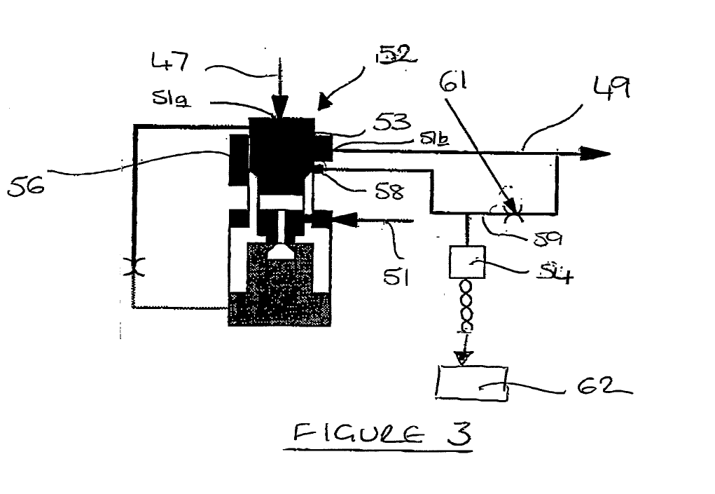

FIG. 3 is a schematic diagram of a part of the apparatus in FIG. 2,

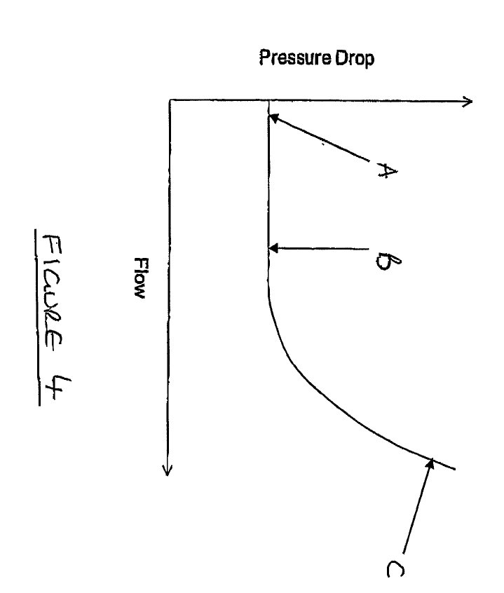

FIG. 4 is a graph to show the difference in pressure across a spill valve arrangement of the apparatus in FIG. 2 against fuel flow through a pressure regulating valve of the apparatus, prior to and upon take off of the aircraft, and

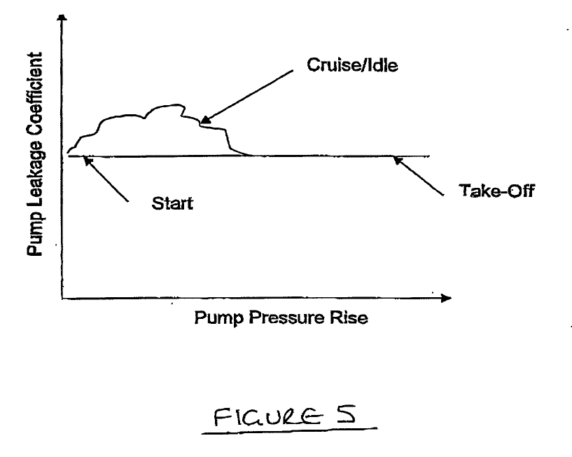

FIG. 5 is a graph to show the pressure leakage coefficient against pump pressure rise for an aircraft engine prior to and upon take off of the aircraft.

One way of motoring the extent of wear of a fuel pump forming part of an engine fuelling system is to measure the internal leakage of fuel from the pump. The phrase “internal fuel leakage” would be familiar to a person skilled in the art and is taken to mean the amount of fuel leakage within the pump mechanism, that is the amount of fuel which passes from the outlet of the pump to the inlet of the pump within the pump mechanism. The internal leakage of fuel from the pump can be calculated by measuring the displacement of the pumps the drive speed of the pump and the fuel flow delivered by the pump. The pump displacement can be calculated from the geometry of the pump in a manner which would be familiar to a person skilled in the art. The pump drive speed can be determined by measuring the engine HP spool speed. It is an object of the present invention to provide a means for measuring the fuel flow delivered by the pump.

Referring to FIGS. 2 and 3, there is shown an apparatus for measuring the pump delivery flow from a fuel pump 40, the pump 40 receiving fuel through a fuel inlet passage 41 and delivering fuel to a fuel metering apparatus 42. The fuel metering apparatus 42 includes a metering valve arrangement 44, a pressure raising and shut-off valve 48, a spill valve arrangement 52 and a pressure sensor 54, the fuel metering unit 42 serving to regulate the flow of fuel from the pump 40 to the engine 45 of an associated aircraft. The pump 40 takes the form of a positive displacement pump, for example a twin pinion gear pump, and delivers fuel to the metering valve arrangement 44 through a delivery passage 46. The metering valve arrangement 44 delivers fuel to the pressure raising valve 48 through a fiber passage 50, the further passage 50 communicating with the spill valve arrangement 52 by means of an additional passage 51.

In order to maintain a substantially constant pressure difference across the metering valve arrangement 44, some of the fuel delivered by the pump 40 to the metering valve arrangement 44 is spilled back from the delivery passage 46 to the inlet passage 41 through the spill valve arrangement 52. Fuel flowing from the delivery passage 46 to the spill valve arrangement 52 flows through a further passage 47 and fuel spilled back through the spill valve arrangement 52 to the inlet passage 41 flows through a spill return passage 49. Fuel which is not spilled back through the spill valve arrangement 52 is delivered through an outlet of the pressure raising valve 48 to the engine 45. It will be appreciated that the fuel flow delivered by the pump 40 through the delivery passage 46 is equal to the sum of the fuel flow through the metering valve arrangement 44 and the fuel flow through the spill valve arrangement 52. For the purpose of this specification, the fuel flow delivered by the pump shall be referred to as the “pump delivery flow”.

As shown in FIG. 3, the spill valve arrangement 52 comprises a spill valve member 53 which is movable within a sleeve member 56 in response to the pressure difference between the further passage 47 in communication with the delivery passage 46 and the additional passage 51 in communication with the further passage 50. The spill valve arrangement 52 includes an inlet port 51a for receiving fuel from the further passage 47, and an outlet port 51b through which fuel is delivered to the spill return passage 49 when the spill valve member 53 moves to an open position. The spill valve arrangement 52 also includes an additional outlet port 58 provided on the sleeve member 56 through which fuel is able to flow when the spill valve member 53 is moved to a position in which fuel is spilled back through the spill return passage 49, such movement of the spill valve member 53 occurring when the pressure difference between the further passage 50 and the delivery passage 46 increases above a predetermined amount. In such circumstances, fuel is able to spill back from the delivery passage 46 to the inlet passage 41 to maintain a substantially constant pressure difference across the metering valve arrangement 44,

The outlet port 58 delivers fuel to a further passage 59, fuel pressure within the passage 59 being measured by means of the pressure sensor 54 which generates an output signal. Typically, the pressure sensor 54 may be a mechanical or a semiconductor pressure transducer. As the spill valve member 53 is opened and fuel is able to escape through the outlet 58 to the further passage 59, the pressure sensor 54 will generate an output signal to indicate that fuel pressure in the further passage 59 has increased. The output signal from the pressure sensor 54 therefore provides an indication of the position of the spill valve member 53.

The further passage 59 is provided with a restriction 61 such that fuel flowing through the outlet port 58 is also able to flow, at a relatively low rate, to the spill return passage 49. The provision of the restriction 61 ensures fuel pressure within the further passage 59 decreases when the outlet port 58 is closed by the spill valve member 53 and also ensures air within the further passage 59 can escape.

The output signal from the sensor 54 is input to an electronic engine control unit 62 associated with the fuelling system. The fuel flow through the spill valve arrangement 52 at the point where the pressure sensor 54 records an increase in pressure in the further passage 59 indicating the position of the spill valve arrangement 52 is known from the geometry of the spill valve port and the set pressure differential across the metering valve arrangement 44. Signals indicative of said opening pressure and said pressure difference are also imputs to the electronic control unit 62.

When the electronic control unit 62 receives a signal from the pressure sensor 54 to indicate an increase in pressure in the further passage 59 the electronic control unit 62 records the HP spool speed. At the same time, the electronic control unit 62 also records an output signal from a sensor (not shown) for measuring the position of a metering valve member forming part of the metering valve arrangement 44 to enable the fuel flow through the metering valve arrangement 44 to be determined. Typically, the sensor for measuring the position of the metering valve member may be an LVDT, an LVIT or a resolver. The information stored in the electronic control unit 62 can then be manipulated to provide an indication of internal fuel leakage from the pump, as will be described herein after.

FIG. 4 shows a graph of the pressure drop across the spill valve arrangement 52 as a function of fuel flow through the pressure raising valve 48 for an aircraft engine following engine start-up. It can be seen that, upon start-up (region A), the pressure drop across the spill valve arrangement 52 is substantially independent of fuel flow through the pressure raising valve 48. The pressure drop across the spill valve arrangement 52 is also substantially independent of fuel flow through the pressure raising valve 48 when the aircraft is cruising (region B). At take-off power (region C) the pressure raising valve 48 opens fully so as to permit a larger amount of fuel to flow to the engine. Under such circumstances, the pressure raising valve 48 acts as a restriction to fuel flow such that the pressure drop across the spill valve arrangement 52 increases for an increasing fuel flow.

As the pressure drop across the spill valve arrangement 52 is independent of fuel flow through the pressure raising valve 48 during the engine starting sequence, by measuring the pump delivery flow at this time consistent pump leakage measurements can be obtained. For the purpose of this specification, the phrase “engine starting sequence” shall be taken to mean the period of time during engine start-up, and prior to aircraft lift-off, for which the pressure drop across the spill valve arrangement 52 is substantially constant.

As the method of the present invention permits both the flow of fuel through the metering valve arrangement 44 and through the spill valve arrangement 52 to be measured, the pump delivery flow can be calculated. As the pump speed is recorded by the electronic control unit 62 and the pump displacement is known, the amount of internal fuel leakage from the pump can be calculated as the difference between these two values.

Alternatively, or in addition, an internal fuel leakage coefficient for the pump may be calculated from the measured pump delivery flow, the leakage coefficient providing an indication of the extent of internal fuel leakage from the pump and, hence, of the extent of wear of the pump. The pump leakage coefficient can be calculated using the following formula;

$${f}_{leak} = \frac{N \cdot P - {f}_{spill} \cdot \sqrt{Δ {p}_{spill}} - {f}_{mmv} ( {x}_{mmv} ) - \sqrt{Δ {p}_{mmv}}}{\sqrt{Δ {p}_{mmv}}}$$

where:

N=pump speed (kRPM),

P=pump displacement (IGPH/kRPM)

ΔPₛₚᵢₗₗ=pressure drop across the spill valve arrangement at the time at which spill valve opening exposes the additional port (58) (psi)

fₛₚᵢₗₗ=valve flow number at the time at which the spill valve opening exposes the additional port (58) (IGPH/√psi)

fₘₘᵥ(Xₘₘᵥ)=metering valve flow number calculated from the metering valve arrangement (44) opening at the time at which the spill valve arrangement (54) opens to expose the additional port (58) (IGPH/√psi), and

ΔPₘₘᵥ=(constant) pressure drop across the metering valve arrangement (44) (psi).

If pump leakage were monitored continuously during cruise and descent conditions, the pressure rise across the pump would be relatively low and the pump speed would be relatively high such that dynamic pressures generated in the volumes of the twin pinion gear pumps may cause bearing blocks to separate from the bearing trust faces. Under such circumstances, the pump leakage characteristic becomes unrepresentative of pump leakage at the critical conditions. This is illustrated in FIG. 5 which shows the pump leakage coefficient as a function of fuel pressure delivered by the pump. It can be seen that during aircraft take off and during start-up the pump leakage coefficient remains substantially constant, whereas during cruising and idling, the pump leakage coefficient varies with pump pressure.

The apparatus in FIG. 2 may also include a computer for receiving a signal indicative of the measured fuel leakage from the pump, the computer being arranged to output a warning signal if the measured fuel leakage exceeds a predetermined fuel leakage value determined by a maximum allowable leakage which still ensures the fuel pump can provide an adequate fuel flow.

Alternatively, the computer may be arranged to provide a warning output signal when fuel leakage from the pump exceeds an amount less than the predetermined amount so as to provide an indication of the remaining service life of the pump before servicing or replacement is required. This provides the advantage that, should an output warning signal arise when a replacement pump is not available, provision can be made to obtain a new pump. Alternatively, or in addition, pump leakage may be measured for every aircraft flight so as to enable the remaining service life of the pump to be predicted.

It will be appreciated that the pump 40 may take the form of another kind of pump, other than a twin pinion gear pump. The method of the present invention may also be used to determine the extent of wear of a fuel pump forming part of a fuelling system for another type of engine, and is not limited to use in an aircraft engine.

1. A method for monitoring the extent of wear a fuel pump having a known displacement and forming part of a fuelling system for an engine, comprising the steps of;
delivering fuel from the fuel pump to a metering valve arrangement for regulating fuel flow from the pump to the engine,
regulating the pressure drop across the metering valve arrangement by means of a spill valve arrangement comprising a spill valve member,
monitoring the position of the spill valve member so as to enable the fuel flow delivered by the pump to be determined, and
using the measured pump delivery flow to provide an indication of fuel leakage from the pump.

2. The method as claimed in claim 1, including the steps of;
measuring the speed of the pump at a predetermined time and using the known pump displacement, the measured pump speed and the measured pump delivery flow at the predetermined time to provide an indication of fuel leakage from the pump.

3. The method as claimed in claim 2, including the step of calculating a pump leakage coefficient to determine the extent of wear of the pump.

4. The method as claimed in claim 2, wherein the predetermined time occurs during a starting sequence of the engine.

5. The method as claimed in claim 4, including the further steps of;
generating an output signal indicative of the fuel leakage from the pump and comparing the output signal with a predetermined maximum fuel leakage value for the pump.

6. The method as claimed in claim 5, including the further step of generating an output warning signal if the output signal exceeds the predetermined maximum fuel leakage value.

7. The method as claimed in claim 5, including the further steps of;
generating an output warning signal when the output signal exceeds an amount less than the predetermined maximum value, and
calculating the period of time for which the pump can be used before servicing or replacement is necessary following generation of the output warning signal.

8. An apparatus for performing the method as claimed in claim 1, comprising;
a metering valve arrangement for regulating fuel flow from the pump to the engine,
a spill valve arrangement comprising a spill valve member for regulating the pressure drop across the metering valve arrangement; and
a further arrangement for monitoring the position of the spill valve member so as to enable the pump delivery flow, and hence the fuel leakage from the pump, to be determined.

9. The apparatus as claimed in claim 8, wherein the spill valve arrangement includes an inlet port, a first outlet port and an additional outlet port such that, in use, when the spill valve member is moved to an open position to permit fuel to spill through the first outlet port to a pump inlet, fuel is able to escape through the additional outlet port.

10. The apparatus as claimed in claim 9, comprising a pressure sensor for sensing the pressure of fuel flowing through the additional outlet port and for providing an output signal indicative of the position of the spill valve member.

11. The apparatus as claimed in claim 10, further comprising a control unit for receiving the output signal and for calculating the fuel leakage from the pump, said control unit being arranged to output an output warning signal if the calculated fuel leakage from the pump exceeds a predetermined amount.

12. The apparatus as claimed in claim 9, wherein the additional outlet port communicates with a further passage provided with a restriction, the restriction permitting fuel pressure within the further passage to decrease when the spill valve member is moved to a position in which the additional outlet port is closed.
